(19) United States
(12) Patent Application Publication
(10) Pub. No.: US 2015/0053555 A1
(43) Pub. Date: Feb. 26, 2015

(54) PENCIL GRAPHITE ELECTRODE MODIFIED WITH GOLD NANOPARTICLES

(71) Applicants: KING ABDULAZIZ CITY FOR SCIENCE AND TECHNOLOGY, RIYADH (SA); KING FAHD UNIVERSITY OF PETROLEUM AND MINERALS, DHAHRAN (SA)

(72) Inventors: ABDEL-NASSER METWALLY ALY KAWDE, DHAHRAN (SA); MD ABDUL AZIZ, DHAHRAN (SA)

(73) Assignee: KING FAHD UNIVERSITY OF PETROLEUM AND MINERALS, DHAHRAN (SA)

(21) Appl. No.: 13/973,992

(22) Filed: Aug. 22, 2013

(51) Int. Cl. G01N 27/30

(52) U.S. Cl. CPC G01N 27/30
USPC 204/400; 427/113

(57) ABSTRACT

The pencil graphite electrode modified with gold nanoparticles can be used for the detection of hydrazine. The pencil graphite electrode has an outer surface coated with gold nanoparticles. Prior to modification of the pencil graphite electrode, equal volumes of an aqueous solution of ascorbic acid and an aqueous solution of gold(III) chloride are mixed to form a mixture containing gold nanoparticles. A pencil graphite electrode is then immersed in the mixture and is heated at a temperature of about 75° C. to form the pencil graphite electrode coated with gold nanoparticles. The pencil graphite electrode coated with gold nanoparticles is then removed from the mixture, washed and dried, and may then be used for the to electrochemical detection of hydrazine.

### BACKGROUND OF THE INVENTION

1. Field of the Invention

The present invention relates to the electrochemical quantization of analytes, and particularly to a pencil graphite electrode modified with gold nanoparticles that can be used for the detection of hydrazine.

2. Description of the Related Art

Pencil graphite electrodes (PGEs) are common electrodes used in a variety of fields, such as electrochemistry, particularly for the electrochemical quantification of various analytes, such as trace metals, organic compounds and nucleic acids. PGEs are common due to their relatively low cost, availability, relatively small thickness, and their adjustable active surface areas, allowing them to be used to detect low analyte concentrations and analyze small sample volumes. Further, due to their low cost and wide availability, PGEs are generally considered to be disposable and easily replaceable.

Analyte detectors and sensors based on nanomaterials, particularly using gold nanoparticles, are of great interest. Gold nanoparticles have desirable electrocatalytic properties with respect to a wide variety of electroactive molecules, including hydrazine, norepinephrine, p-aminophenol, acetaminophen and atenolol. Using gold nanoparticles in combination with conventional electrode structures, however, is relatively difficult, as it requires costly, difficult and time consuming processes, such as chemical vapor deposition, cross-linking molecules, complex heat treatments and the like. It would be desirable to be able to manufacture pencil graphite electrodes modified with gold nanoparticles for detection of hydrazine and the like.

Thus, a pencil graphite electrode modified with gold nanoparticles solving the aforementioned problems is desired.

### SUMMARY OF THE INVENTION

The pencil graphite electrode modified with gold nanoparticles can be used for the detection of hydrazine. The pencil graphite electrode has an outer surface coated with gold nanoparticles. Prior to modification of the pencil graphite electrode, equal volumes of an aqueous solution of ascorbic acid and an aqueous solution of gold(III) chloride are mixed to form a mixture containing gold nanoparticles. The pencil graphite electrode is then immersed in the mixture and is heated at a temperature of about 75° C. to form the pencil graphite electrode coated with gold nanoparticles. The pencil graphite electrode coated with gold nanoparticles is then removed from the mixture, washed and dried, and may then be used for the electrochemical detection of hydrazine.

These and other features of the present invention will become readily apparent upon further review of the following specification.

### BRIEF DESCRIPTION OF THE DRAWINGS

FIG. 1 is a graph comparing cyclic voltammograms of (a) unmodified pencil graphite electrodes against (b) pencil graphite electrodes modified with gold nanoparticles according to the present invention, both in 0.1 M NaOH.

FIG. 2A is a comparison of cyclic voltammograms of (a) unmodified pencil graphite electrodes against (b) pencil graphite electrodes modified with gold nanoparticles according to the present invention, both in 0.1 M phosphate buffered saline (pH of 7) and at a scan rate of 100 mV/s.

FIG. 2B is a comparison of cyclic voltammograms of (a) unmodified pencil graphite electrodes against (b) pencil graphite electrodes modified with gold nanoparticles according to the present invention, both in 0.1 M phosphate buffered saline (pH of 7) in the presence of hydrazine at a scan rate of 100 mV/s.

FIG. 3A shows a field emission scanning electron microscope (SEM) surface image of an unmodified pencil graphite electrode sample at a scale bar of 2 μm.

FIG. 3B shows a field emission scanning electron microscope (SEM) surface image of a gold nanoparticle-modified pencil graphite electrode sample prepared at room temperature at a scale bar of 2 μm.

FIG. 3C shows a field emission scanning electron microscope (SEM) surface image of a pencil graphite electrode modified with gold nanoparticles according to the present invention at a scale bar of 2 μm.

FIG. 3D shows a field emission scanning electron microscope (SEM) surface image of an unmodified pencil graphite electrode sample at a scale bar of 200 nm.

FIG. 3E shows a field emission scanning electron microscope (SEM) surface image of a gold nanoparticle-modified pencil graphite electrode sample prepared at room temperature at a scale bar of 200 nm.

FIG. 3F shows a field emission scanning electron microscope (SEM) surface image of a pencil graphite electrode modified with gold nanoparticles according to the present invention at a scale bar of 200 nm.

FIG. 4A is a comparison of square wave voltammograms of a pencil graphite electrode modified with gold nanoparticles according to the present invention for 25 μM hydrazine in 0.1 M phosphate buffered saline at varying pH values of (a) 4.5, (b) 5.0, (c) 6.0 and (d) 7.0.

FIG. 4B illustrates plots of pH vs. peak current and peak potential for the square wave voltammograms of FIG. 4A.

FIG. 5A is a plot of peak current vs. pulse width for the square wave voltammograms of 25 μM hydrazine in 0.1 M phosphate buffered saline (pH 7.0).

FIG. 5B is a plot of peak current vs. amplitude for the square wave voltammograms of 25 μM hydrazine in 0.1 M phosphate buffered saline (pH 7.0).

FIG. 5C is a plot of peak current vs. frequency for the square wave voltammograms of 25 μM hydrazine in 0.1 M phosphate buffered saline (pH 7.0).

FIG. 6 is a comparison of square wave voltammograms for the pencil graphite electrode modified with gold nanoparticles according to the present invention for varying concentrations of hydrazine in 0.1 M phosphate buffered saline at a pH of 5.0.

FIG. 7 is a comparison of square wave voltammograms for the pencil graphite electrode modified with gold nanoparticles according to the present invention, comparing values for (a) 25 μM hydrazine against (b) 100 μM phenol, (c) a mixture of 25 μM hydrazine and 100 μM phenol, (d) 100 μM 3,4 dichlorophenol, (e) a mixture of 25 μM hydrazine and (f) 100 μM 3,4 dichlorophenol, and a mixture of 25 μM hydrazine, 100 μM phenol and 100 μM 3,4 dichlorophenol.

Similar reference characters denote corresponding features consistently throughout the attached drawings.

### DETAILED DESCRIPTION OF THE PREFERRED EMBODIMENTS

The pencil graphite electrode modified with gold nanoparticles can be used for the detection of hydrazine. The pencil graphite electrode has an outer surface coated with gold nanoparticles. Prior to modification of the pencil graphite electrode, equal volumes of an aqueous solution of ascorbic acid and an aqueous solution of gold(III) chloride are mixed to form a mixture containing gold nanoparticles. A pencil graphite electrode is then immersed in the mixture and is heated at a temperature of about 75° C. to form the pencil graphite electrode coated with gold nanoparticles. The pencil graphite electrode coated with gold nanoparticles is then removed from the mixture, washed and dried, and may then be used for the electrochemical detection and quantification of hydrazine.

In order to prepare the pencil graphite electrode modified with gold nanoparticles, equal volumes (1.5 mL of each in aqueous solution) of 1.65 mM ascorbic acid and 1.0 mM gold(III) chloride were mixed using a pipette at room temperature in a 3.0 mL test tube to form gold nanoparticles. An un-modified pencil graphite electrode (PGE) was immersed in the mixture of the test tube, and the test tube was then placed into a water bath that had been preheated to 75° C. The PGE remained within the test tube in the water bath for a period of 15 minutes to form a PGE modified with gold nanoparticles (AuNPs). The AuNP-modified PGE was removed from the test tube and then washed twice by gentle dipping in deionized water. The AuNP-modified PGE was then dried at 60° C. for five minutes, prior to use.

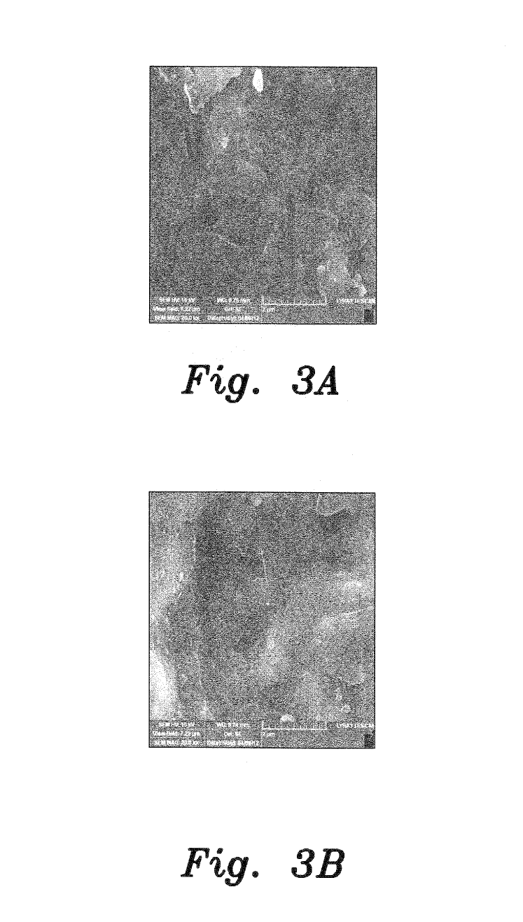

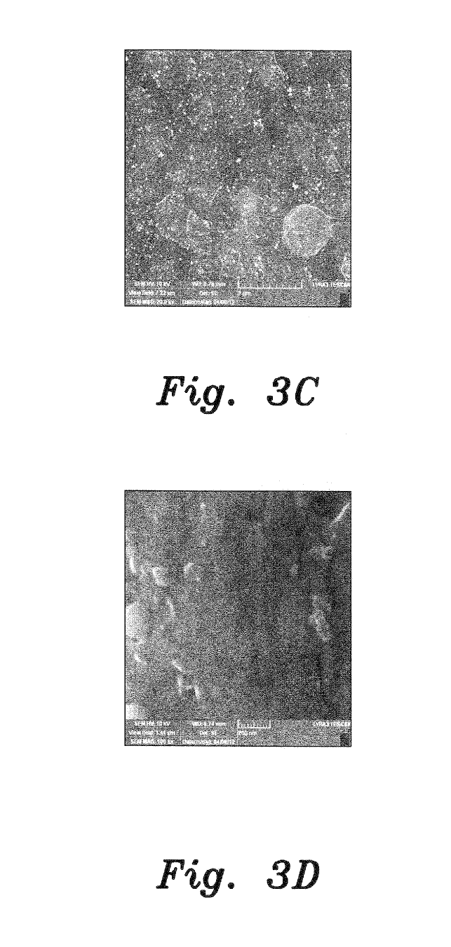

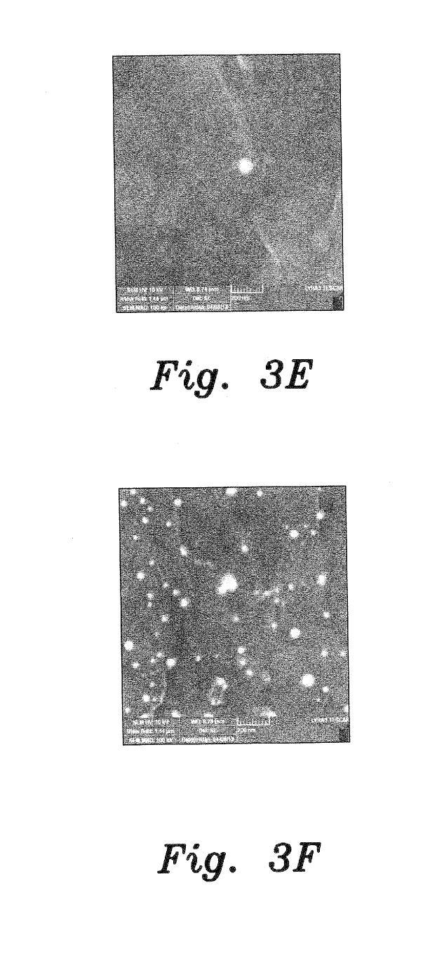

Another sample was also produced, for purposes of experimental comparison, at room temperature (i.e., without immersion in a water bath at 75° C.). A field emission scanning electron microscope (FE-SEM) was used to compare the room temperature samples against the samples produced by the method described above. FIGS. 3A and 3D show electron micrographs of un-modified PGEs at 2 μm and 200 nm scales, respectively. FIGS. 3B and 3E show electron micrographs of the room temperature sample at 2 μm and 200 nm scales, respectively. As shown, the comparative sample produced at room temperature showed AuNPs that were barely attached to the surface of the PGE. In contradistinction, FIGS. 3C and 3F show electron micrographs of the AuNP-modified PGE sample at 2 μm and 200 nm scales, respectively, produced with the 75° C. water bath. This sample clearly shows efficient attachment of the AuNPs to the surface. The AuNPs on the surface of the PGE had diameters in the range of 20 to 85 nm with a homogenous distribution.

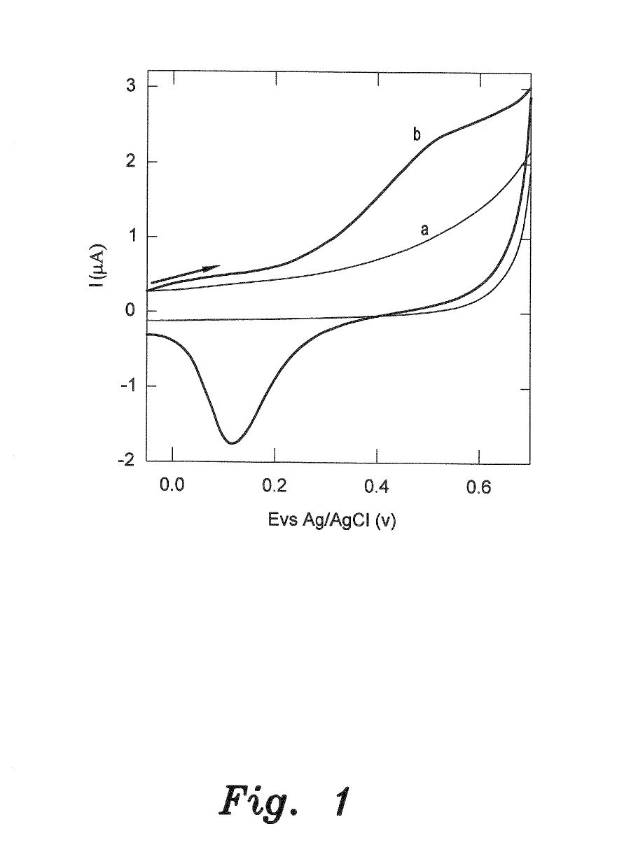

In order to further prove the presence of gold nanoparticles on the AuNP-modified PGEs, cyclic voltammograms (CVs) of an un-modified PGE (curve “a” in FIG. 1) and an AuNP-modified PGE (curve “b” in FIG. 1) were recorded in 0.1 M NaOH. The CV of the AuNP-modified PGE shows higher anodic and cathodic current than that of the un-modified PGE. Further, the cathodic peak at 0.119 V appears only in the CV of the AuNP-modified PGE. Only the CV of the AuNP-modified PGE shows the characteristic redox signal of gold. Thus, the presence of gold on the AuNP-modified PGEs has been confirmed.

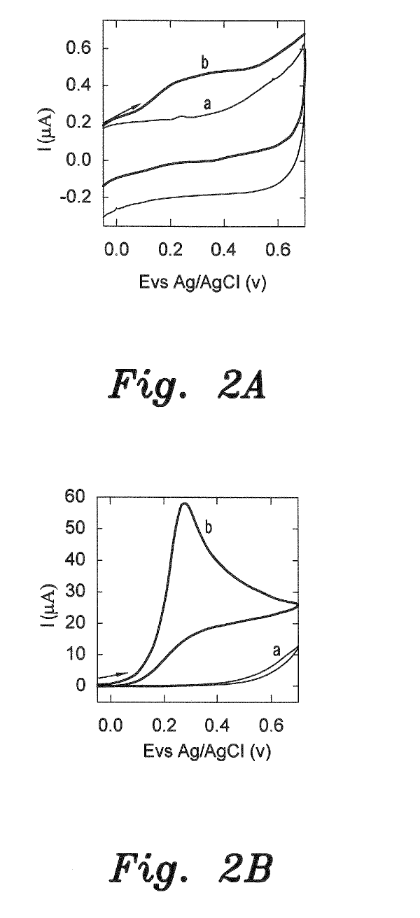

In order to study the electrocatalytic properties of the AuNP-modified PGEs for hydrazine oxidation, the electrocatalytic performance of both un-modified PGE and the AuNP-modified PGEs were evaluated by recording CVs in phosphate buffered saline (PBS) (0.1 M, pH 7) in the absence of hydrazine (FIG. 2A) and in the presence of 0.5 mM hydrazine (FIG. 2B), The anodic current of the AuNP-modified PGE (curve “b” in FIG. 2A) in 0.1M PBS (pH 7.0) is slightly higher than that of the un-modified PGE (curve “a” in FIG. 2A). The cause of this higher background current in the anodic scan may be gold oxidation. As shown in curve “a” of FIG. 2B, the un-modified PGE cannot oxidize at potentials less than 0.4 V and cannot show an oxidation peak in the entire tested potential window; i.e., the un-modified PGE requires an over potential for the electro-oxidation of hydrazine. In contradistinction, hydrazine oxidation begins at nearly the starting potential of the CV (curve “b” of FIG. 2B) for the AuNP-modified PGE, and its oxidation peak appears at 0.28 V. The oxidation current of hydrazine for the AuNP-modified PGE is much higher than that obtained for the un-modified PGE. These results clearly indicate the presence of AuNPs on the PGE, enhancing the signal and reducing the over-potential for the hydrazine electro-oxidation, which are essential to the fabrication of sensitive and selective electrochemical hydrazine sensors.

The CV technique does have a limitation, in that its background current is often a barrier in achieving highly sensitive detection limits in electroanalysis. Thus, square wave voltammetry (SWV) is also used, particularly due to its high sensitivity and superior capability in suppression of unwanted background currents. However, the sensitivity of SWV is partially dependent on the pH and the parameters of the SWV. As a result, the pH effect and parameters of SWV for electro-oxidation of hydrazine were also studied.

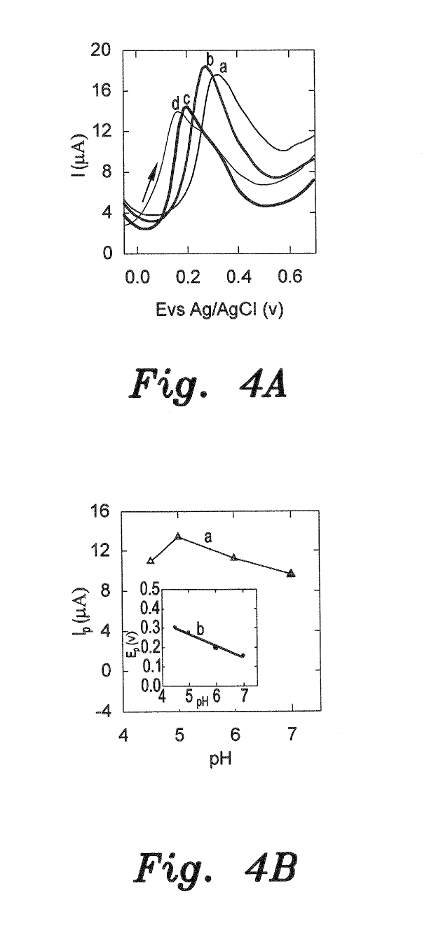

FIG. 4A shows the square wave voltammograms of 25 μM hydrazine in 0.1 M PBS with varying pH values of 4.5 (curve “a”), 5.0 (curve “b”), 6.0 (curve “c”) and 7.0 (curve “d”) for the AuNP-modified PGE. The SWV was performed with a pulse width/increment of 15 mV, a pulse height/amplitude of 100 mV, and at a frequency of 30 MHz. FIG. 4B is a corresponding plot of pH vs. peak current (plot “a”) and peak potential (plot “b”). As shown, as the pH value increased, the electro-oxidation peak potential (Eₚ) of hydrazine was shifted linearly toward a less positive potential at a slope of −61.5 mV per pH unit, which is very close to the anticipated Nernstian slope of −59 mV for a four-electron, four-proton process. Thus, the mechanism of the hydrazine oxidation for the AuNP-modified PGE can be expressed as: N₂H₄→N₂+4H⁺+4e⁻. As shown in curve “a” of FIG. 4B, a pH of 5.0 gives the highest electro-oxidation signal, with a peak potential of 0.275 V. As a result, a pH of 5.0 was selected as the optimum pH for the further experiments.

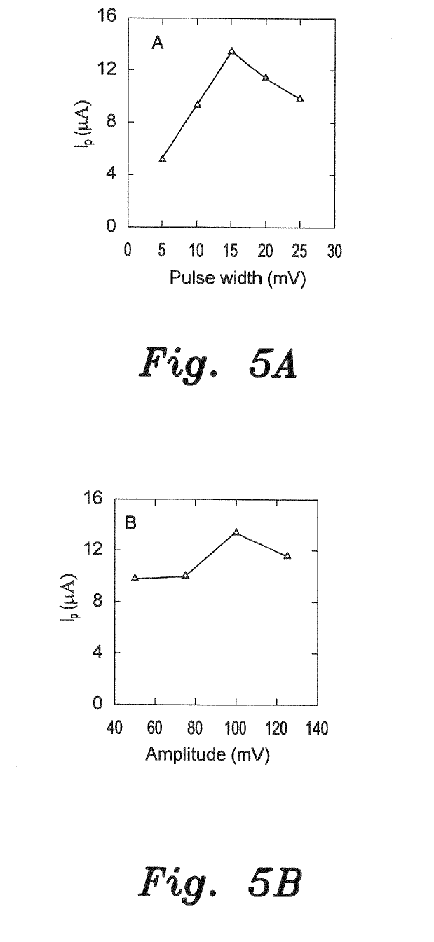

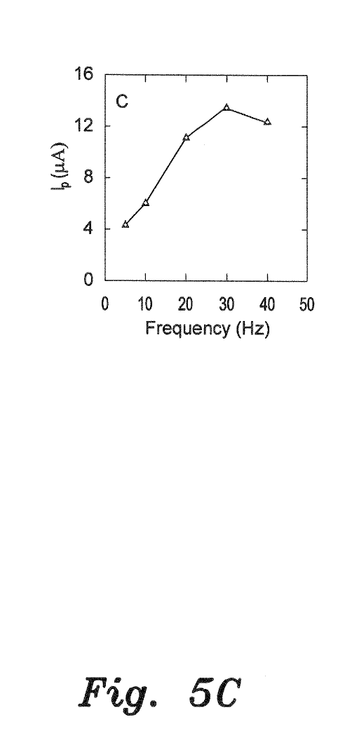

The effects of changing pulse width (FIG. 5A), amplitude (FIG. 5B) and frequency (FIG. 5C) on SWV signal for electro-oxidation of 25 μM hydrazine in PBS (0.1 M, pH 5.0) for the AuNP-modified PGE were also studied. By examining the peak current, an optimal pulse width of 15 mV, an optimal amplitude of 100 mV, and an optimal frequency of 30 Hz were found. The experiment was reproduced by recording SWVs at five different modified electrode surfaces. The cumulative data show a peak current of 12.69±0.62 (mean±standard deviation) with an RSD of 4.89%.

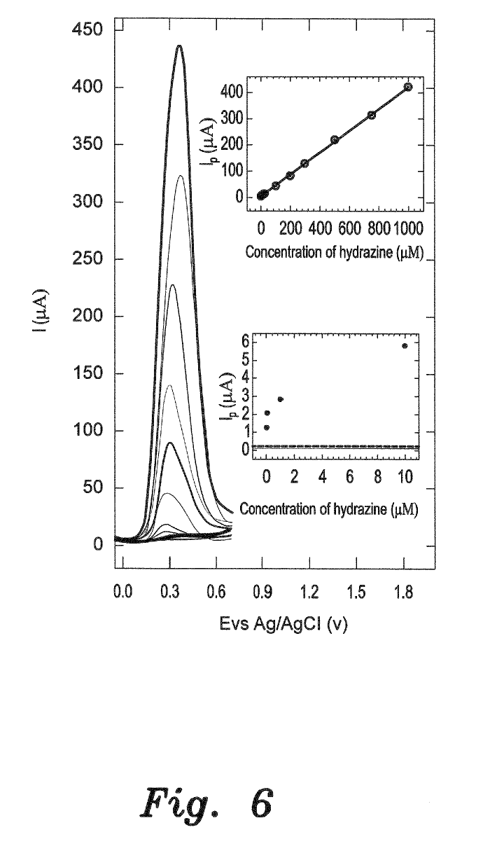

The hydrazine concentration dependence SWVs under the optimum conditions for the AuNP-modified PGE samples were recorded to obtain limits of quantification. The calibration curve of all concentrations (upper inset in FIG. 6) shows the signal increasing linearly with increasing concentrations of hydrazine. However, the magnified view of the calibration curve for low concentrations (lower inset of FIG. 6) shows a non-linear signal as a function of concentration. The sensitivity for low concentrations is higher compared to that of higher concentrations. The reason for this may be a change in the surface conditions due to the generation of molecular nitrogen bubbles. Finding the exact value of sensitivity for low concentrations is not possible due to the non-linear behavior of the corresponding calibration curve (lower inset of FIG. 6). It should be noted that the peak current of 50 nM hydrazine (1.238 μA) is higher than the sum of signal (0.109 μA) and three standard deviations (0.0350 μA) of the blank solution (lower inset of FIG. 6); i.e., the limit of quantification of the present AuNP-modified PGE is 50 nM hydrazine. This limit of quantification of hydrazine is much lower than the limit of quantification of conventional nanomaterial-modified carbon-based electrodes.

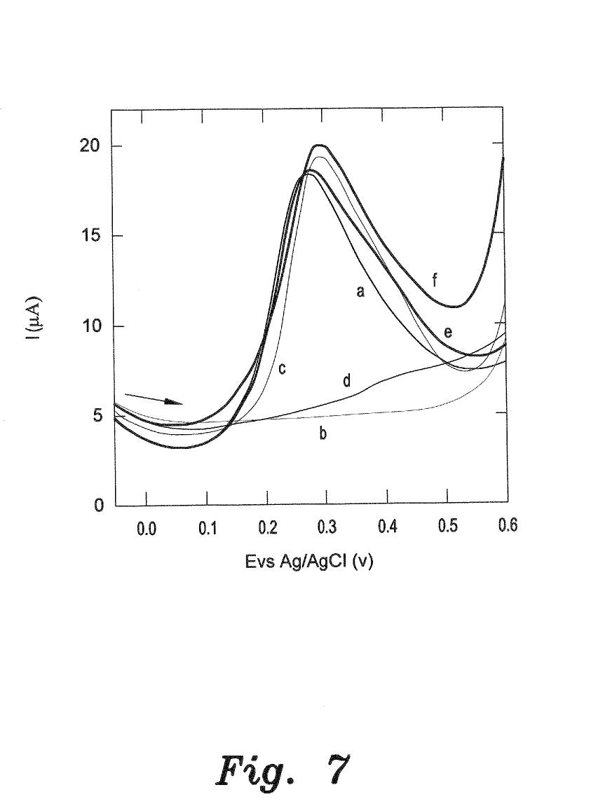

The interference effect of phenolic compounds (phenol and 3,4 dichlorophenol), which commonly exist as hazardous materials in the environment, on the signal of 25 μM hydrazine for the AuNP-modified PGE samples was also studied, as shown in FIG. 7. The SWVs of the AuNP-modified PGE in PBS (0.1 M, pH 5) containing 25 μM hydrazine (curve “a”), 100 μM phenol (curve “b”), 25 μM hydrazine and 100 μM phenol (curve “c”), 100 μM 3,4 dichlorophenol (curve “d”), 25 μM hydrazine and 100 μM 3,4 dichlorophenol (curve “e”), and 25 μM hydrazine, 100 μM phenol and 100 μM 3,4 dichlorophenol (curve “f”) were recorded. The SWV of hydrazine in the absence of interferent or presence of interferent are similar, except for a small peak position shift toward the positive potential. However, the peak potential of hydrazine in the presence of interferent is still enough for the selective determination of hydrazine.

It is to be understood that the present invention is not limited to the embodiments described above, but encompasses any and all embodiments within the scope of the following claims.

We claim:

1. A pencil graphite electrode modified with gold nanoparticles, comprising a pencil graphite electrode having an outer surface coated with gold nanoparticles.

2. The pencil graphite electrode modified with gold nanoparticles as recited in claim 1, wherein each said gold nanoparticle has a diameter between 20 nm and 85 nm.

3. The pencil graphite electrode modified with gold nanoparticles as recited in claim 2, wherein the gold nanoparticles are homogenously distributed on the outer surface of the pencil graphite electrode.

4. A method of making a pencil graphite electrode modified with gold nanoparticles, comprising the steps of:
mixing equal volumes of an aqueous solution of ascorbic acid and an aqueous solution of gold(III) chloride to form a mixture containing gold nanoparticles;
immersing a pencil graphite electrode in the mixture; and
heating the immersed pencil graphite electrode at a temperature of about 75° C. to form a pencil graphite electrode coated with gold nanoparticles, whereby the gold nanoparticles are securely attached to the surface of the electrode.

5. The method of making a pencil graphite electrode modified with gold nanoparticles as recited in claim 4, wherein the aqueous solution of ascorbic acid has a concentration of about 1.65 mM and the aqueous solution of gold(III) chloride has a concentration of about 1.0 mM.

6. The method of making a pencil graphite electrode modified with gold nanoparticles as recited in claim 4, wherein the step of mixing equal volumes is performed at room temperature.

7. The method of making a pencil graphite electrode modified with gold nanoparticles as recited in claim 4, wherein the step of heating the immersed pencil graphite electrode comprises heating the immersed pencil graphite electrode in a water bath having a temperature of about 75° C.

8. The method of making a pencil graphite electrode modified with gold nanoparticles as recited in claim 4, wherein the step of heating the immersed pencil graphite electrode comprises heating the immersed pencil graphite electrode for a period of about 15 minutes.

9. The method of making a pencil graphite electrode modified with gold nanoparticles as recited in claim 4, further comprising the step of drying the pencil graphite electrode coated with gold nanoparticles at a temperature of about 60° C. for about 5 minutes.
